(19) United States
(12) Patent Application Publication
(10) Pub. No.: US 2015/0057475 A1
(43) Pub. Date: Feb. 26, 2015

(54) BI-FUNCTIONAL CATALYST AND PROCESSES FOR CONVERSION OF BIOMASS TO FUEL-RANGE HYDROCARBONS

(71) Applicants: Huamin Wang, Richland, WA (US); Guo-Shuh J. Lee, Richland, WA (US); Suh-Jane Lee, Richland, WA (US)

(72) Inventors: Huamin Wang, Richland, WA (US); Guo-Shuh J. Lee, Richland, WA (US); Suh-Jane Lee, Richland, WA (US)

(73) Assignee: BATTELLE MEMORIAL INSTITUTE, Richland, WA (US)

(21) Appl. No.: 13/975,090

(22) Filed: Aug. 23, 2013

(51) Int. Cl. C10G 3/00; B01J 29/44

(52) U.S. Cl. CPC C10G 3/50; B01J 29/44
USPC 585/251; 585/357; 422/630; 502/60; 502/74; 502/77

(57) ABSTRACT

Processes and bi-functional catalysts are disclosed for hydrotreating bio-oils derived from biomass to produce bio-oils containing fuel range hydrocarbons suitable as feedstocks for production of bio-based fuels.

### STATEMENT REGARDING RIGHTS TO INVENTION MADE UNDER FEDERALLY-SPONSORED RESEARCH AND DEVELOPMENT

This invention was made with Government support under Contract DE-AC05-76RLO1830 awarded by the U.S. Department of Energy. The Government has certain rights in the invention.

### FIELD OF THE INVENTION

The present invention relates generally to methods and catalysts for conversion of fast pyrolysis bio-oils. More particularly, the invention relates to a bi-functional catalyst and process for upgrading bio-oils to include fuel-range hydrocarbons.

### BACKGROUND OF THE INVENTION

Considerable world-wide interest exists in renewable energy sources as a substitute for fossil fuels. Lignocellulosic biomass, the most abundant and inexpensive renewable feedstock on the planet, has great potential for sustainable production of fuels, chemicals, and carbon-based materials.

Biomass may be converted to liquid bio-oils by fast pyrolysis. Fast pyrolysis is a thermochemical process that thermally decomposes lignocellulose in the absence of oxygen at temperatures between about 375° C. and about 600° C. Reactions including, e.g., depolymerization, dehydration, and cleavage of carbon-carbon bonds occur that lead to the formation of the bio-oil, also termed “fast pyrolysis oil”. However, fast pyrolysis bio-oils contain complex mixtures of over 200 types of oxygenated compounds that give these bio-oils a high oxygen content between, e.g., about 43 wt % and about 50 wt %. The high oxygen content gives these bio-oils poor physical and chemical properties (and combustion behavior) compared to petroleum oils including, e.g., a low heating value, a low viscosity, a poor stability, and a low volatility. TABLE 1 compares composition and selected physical properties of a typical fast pyrolysis bio-oil and a standard petroleum oil.

TABLE 1
compares composition and physical properties of a bio-oil derived
from wood biomass and a conventional fuel oil.

| Elementary Analysis | Wood Pyrolysis Bio-Oil | Fuel Oil |
|---|---|---|
| Carbon (wt %) | 40-50 | 85 |
| Hydrogen (wt %) | 6.0-7.6 | 11-13 |
| Oxygen (wt %) | 36-52 | 0.1-1.0 |
| Sulfur (wt %) | 0.0-0.02 | 1.0-1.8 |
| Nitrogen (wt %) | 0.00-0.15 | 0.1 |
| Water (wt %) | 17-30 | 0.02-0.1 |
| Solid (wt %) | 0.03-0.7 | 1 |
| pH | 2.4-2.8 | — |
| Viscosity (cP) (323K) | 13-30 | 180 |
| Higher Heating Value | 16-20 | 40 |
| (Gross Energy) | | |
| (MJ/kg) | | |
| Density (kg/m³) | 1.2-1.3 | 0.9-1.0 |

Bio-oils are also corrosive compared to their petroleum-based counterparts due to their high oxygen content, which presents problems in equipment used for processing. Oxygen-containing species in bio-oils also contain large quantities of unsaturated double bonds including, e.g., olefins, aldehydes, ketones that are highly reactive and can re-polymerize through condensation reactions to form tars that plug reactors and encapsulate or inactivate catalysts.

Bio-oils can be hydrotreated to reduce the oxygen content in the bio-oils so that properties are similar to those of standard petroleum liquids. However, due to the high costs associated with upgrading, upgrading bio-oils remains a pressing problem for large-scale application of biomass conversion. Accordingly new processes and catalysts are needed that improve the hydrotreatment of fast pyrolysis bio-oils that increase the yield of fuel-range hydrocarbons in these bio-oils that are suitable for production of fuels. The present invention addresses these needs.

### SUMMARY OF THE INVENTION

The present invention includes a process for hydrotreating bio-oils including fast pyrolysis bio-oils to produce an upgraded bio-oil that contains fuel-range hydrocarbons. The term “fuel-range” means hydrocarbons with a carbon number of from about C=3 to about C=18. The upgraded bio-oil may be introduced as a bio-based feedstock to a petroleum refinery for production of fuels including, e.g., jet fuel, gasoline, and diesel.

In some applications, a two-step hydrotreating process may be performed in a two-stage reactor system configured with a primary catalytic reactor coupled with a secondary catalytic reactor. Each reactor may be independently controlled and operated.

In some applications, the process may be performed continuously or may be performed batch-wise.

In a first step (i.e., 1^{st} of two steps), hydrogenation (HYD) of the bio-oil may be performed in a first stage reactor charged with a selected hydrogenation catalyst at selected operating conditions. Hydrogenation stabilizes the bio-oil by converting reactive oxygen-containing coke-forming compounds including, e.g., aldehydes, ketones, unsaturated polymers, and like compounds into non-coke-forming oxygen-containing compounds such as, e.g., alcohols, ethers, and/or monomers, and other oxygen-free compounds including, e.g., unsaturated aromatics, alkenes, alkynes, and like compounds. The hydrogenation catalyst may include a metal on a solid metal oxide support. Concentrations of the metal in the hydrogenation catalyst may be from about 0.5% to about 10% by weight. The metal oxide support may include a concentration of between about 90% and about 99.5% by weight. Metals of the catalyst may include, but are not limited to: ruthenium (Ru), rhenium (Re), palladium (Pd), platinum (Pt), nickel (Ni), and combinations of these metals. Metal oxide supports may include, e.g., titania (TiO₂), zirconia (ZrO₂), alumina (Al₂O₃), and silica (SiO₂). Hydrogenation [HYD] may be performed at a hydrogen (H₂) gas pressure of from about 3.0 MPa to about 12.0 MPa at a temperature below 200° C. Hydrogenation removes reactive carbonyl-containing compounds that form char to below a concentration of about 1 wt % that stabilizes the bio-oil.

In a second step (i.e., 2^{nd} of two steps), hydrodeoxygenation (HDO) of the bio-oil may be performed in a second stage reactor charged with a bi-functional hydrodeoxygenation catalyst. Hydrodeoxygenation involves reactions that add hydrogen that converts oxygen-containing non-coke-forming compounds into saturated hydrocarbons including, e.g., alkanes and cycloalkanes with a carbon number of from about C=3 to about C=18. The bi-functional catalyst may include a metal on a solid metal oxide support in combination with a solid acid or a metal on a solid acid support. Metals of the bi-functional catalyst may include, but are not limited to: ruthenium (Ru), rhenium (Re), palladium (Pd), platinum (Pt), nickel (Ni), and combinations of these metals. In some applications, metals of the bi-functional catalyst may include a concentration of from about 0.5% to about 10% by weight. Solid metal oxide supports of the bi-functional catalyst may include, e.g., titania (TiO₂), zirconia (ZrO₂), alumina (Al₂O₃), and silica (SiO₂). In some applications, the solid metal oxide may include a concentration of between about 20% and about 90% by weight.

The solid acid or the solid acid support may include selected concentrations of an acidic metal oxide or an acid zeolite. Acidic metal oxides of the bi-functional catalyst may include: titania (TiO₂), zirconia (ZrO₂), amorphous alumina-silica (Al₂O₃—SiO₂), niobic acid, tungstic acid, molybdic acid, and combinations of these acid metal oxides. In various applications, the acidic metal oxide may include a concentration of between about 10% and about 80% by weight. Acid zeolites of the bi-functional catalyst may include: Y zeolites, Beta zeolites, ZSM-5 zeolites, Mordenite zeolites, Ferrierite zeolites, Al-MCM-41 zeolites, MCM-48 zeolites, MCM-22 zeolites, SAPO-34 zeolites, Chabazite zeolites, and combinations of these acid zeolites.

In some applications, the acid zeolite may be a hydrogen-exchanged zeolite.

In various applications, the acid zeolite may include a concentration of between about 10% and about 80% by weight.

In some applications, the bi-functional catalyst may include a metal concentration of from about 0.5 wt % to about 10 wt %, and a solid acid concentration of between about 90 wt % and about 99.5 wt %.

In the second stage, hydrodeoxygenation may be performed at a hydrogen (H₂) gas pressure of from about 3.0 MPa to about 12.0 MPa at a temperature from about 200° C. to about 400° C. The second step hydrodeoxygenation yields a product containing fuel range hydrocarbons. The product oil is a suitable bio-based feedstock for production of fuels.

The two-step hydrotreating process converts bio-oils whether catalytic or non-catalytic in the presence of hydrogen gas at selected pressures and temperatures into upgraded product bio-oils that contain fuel range hydrocarbons suitable for use as feedstocks for production of fuels. Fuel-range hydrocarbons may include, but are not limited to, e.g., C3-C18 alkanes and C3-C18 cycloalkanes.

In some applications, the two-step hydrotreating process may be performed in a single stage reactor. Hydrogenation of the bio-oil may be performed in the reactor that is charged with the hydrogenation catalyst at selected operating conditions. The reactor may be re-charged with a bi-functional catalyst and the second step hydrodeoxygenation may be performed in the reactor over the hydrodeoxygenation catalyst.

In some applications, the hydrogenation and hydrodeoxygenation steps may be performed remotely or in separate reactors when configured with the selected catalysts operated at the selected operating conditions.

The present invention does not employ conventional sulfide-containing catalysts due to the improved hydrogenation activity of catalysts of the present invention which also minimizes coke formation compared with operation with sulfide-containing catalysts sulfided including Co—Mo catalysts.

Catalysts of the present invention may be regenerated in the presence of oxygen to remove any coke formed on the catalysts during operation by oxidation at temperatures as high as 500° C., far higher than conventional carbon-based catalysts.

The purpose of the foregoing abstract is to enable the United States Patent and Trademark Office and the public generally, especially the scientists, engineers, and practitioners in the art who are not familiar with patent or legal terms or phraseology, to determine the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 shows a two-stage reactor system for upgrading fast pyrolysis bio-oils, according to one embodiment of the present invention.

FIG. 2 shows typical temperatures for a dual stage reactor system of the present invention for upgrading fast pyrolysis bio-oils.

FIG. 3 shows a one-stage reactor system for upgrading fast pyrolysis bio-oils, according to another embodiment of the present invention.

FIG. 4 shows a reaction scheme for conversion of quaiacol on supported metal catalysts, according to an embodiment of the present invention.

FIG. 5 shows yields of product gases and product bio-oil and density of the product bio-oil from two-stage hydrotreatment of a raw catalytic bio-oil as a function of time on stream.

FIG. 6 shows yields of product gases and product bio-oil and density of the product bio-oil from two-stage hydrotreatment of a raw non-catalytic bio-oil as a function of time on stream.

FIG. 7 is a GC-MS spectrum of components in product liquids obtained from raw bio-oil hydrotreated in a two-stage reactor at a time on stream of between 126 hrs. and 132 hrs.

### DETAILED DESCRIPTION

A two-step process and bi-functional catalyst are described for hydrotreating (upgrading) bio-oils derived from catalytic and non-catalytic fast pyrolysis of biomass. The treated bio-oils contain fuel-range hydrocarbons that may be used as bio-based feedstocks in petroleum refineries and processed into fuel. The following description includes a best mode of the present invention. While preferred embodiments of the present invention will be described, it will be apparent from the description that various modifications, alterations, and substitutions may be made without departing from the scope of the invention. Accordingly, the description of the preferred embodiments should be seen as illustrative only and not limiting. The present invention covers all modifications, alternative constructions, and equivalents falling within the scope of the present invention as defined in the claims. Therefore the present description should be seen as illustrative and not limiting.

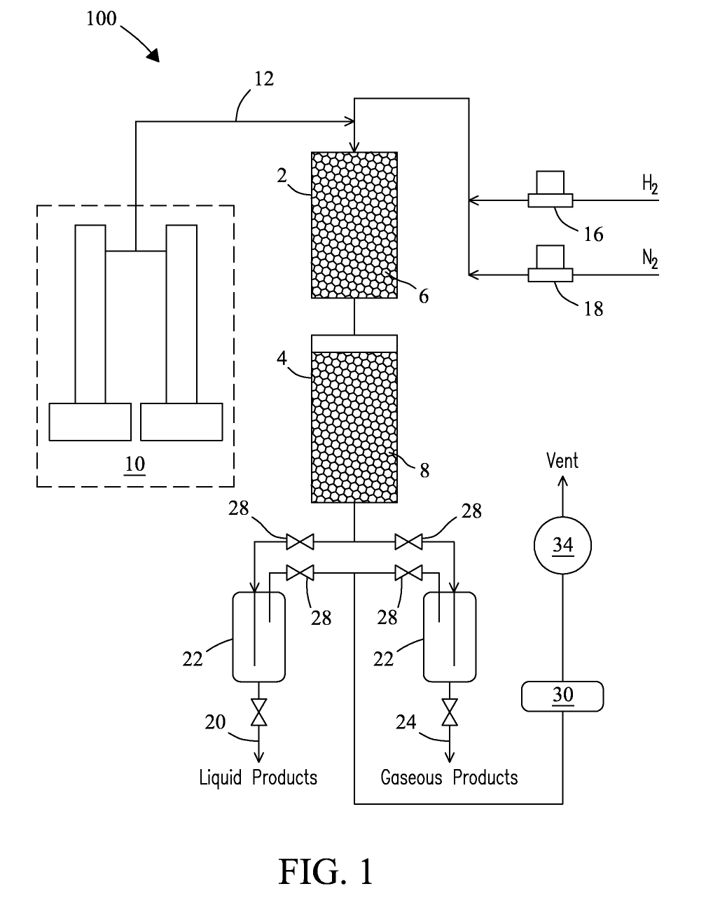

FIG. 1 shows an exemplary two-stage reactor system 100 for hydrotreating (upgrading) bio-oils including fast pyrolysis bio-oils. System 100 may include two reactor stages 2 and 4 each with a distinct catalyst bed, or two separate catalyst beds in a single reactor. In various embodiments, each reactor stage may be charged with a selected catalyst. Reactors may be of any type that provides contact between the bio-oil and the selected catalyst. In the instant embodiment, reactor stages 2 and 4 are of a fixed-bed type, but reactors are not intended to be limited. Reactors suitable for use include, but are not limited to, e.g., fixed-bed reactors, fluidized bed reactors, circulating fluid-bed reactors, rotating cone reactors, batch reactors, batch-flow reactors, packed-bed reactors, tubular reactors, multi-tubular reactors, network reactors, heat-exchange reactors, gas-liquid reactors, gas-solid reactors, radial-flow reactors, reverse-flow reactors, ring reactors, moving bed reactors, catalytic reactors, non-catalytic reactors, chemical reactors, gas reactors, trickle-bed reactors, column reactors, batch reactors, N-dimensional reactors and N-phase reactors (where N is a number of dimensions or phases), heated reactors, cooled reactors, including combinations and components of these various reactors.

First stage reactor 2 may be charged with a hydrogenation catalyst 6. Hydrogenation catalyst 6 may include a metal supported on a selected solid support. The solid support may include selected metal oxides. Various reactors may be used in concert with the invention, as detailed herein. Reactors stages 2 and 4 may be directly coupled or remotely coupled. In the figure, reactor stages 2 and 4 are shown directly coupled, as described herein. Second stage reactor 4 may be charged with a selected bi-functional catalyst 8 of the present invention that provides hydrodeoxygenation of the bio-oil, as described further herein.

System 100 may include a liquid feed delivery or introduction device 10 such as a high-pressure metering syringe pump 10 (e.g., a dual-head pump, Teledyne-ISCO, Inc., Lincoln, Neb., USA) or other introduction device that delivers a liquid feed 12 comprising a bio-oil (not shown) into first stage reactor 2. Hydrogen gas may be introduced into first stage reactor 2 at a selected flow rate and a selected pressure controlled, e.g., with a mass flow controller 16. A second mass flow controller 18 may provide a purge gas such as nitrogen (N₂) for pressure testing or purging of reactors 2 and 4 prior to and after operation.

In the figure, bio-oil and hydrogen gas may enter, e.g., from the top of reactor 2 and be passed through the catalyst 6 at a selected temperature, e.g., in a trickle flow mode. Temperature of the reactor and catalyst may be controlled and monitored, e.g., with heating devices and temperature measuring devices (e.g., thermocouples) known in the reactor processing art. No limitations are intended. In various embodiments, hydrogenation may be performed at various space velocities. Space velocities are not limited. Space velocities may be selected that optimize treatment of bio-oil volumes per unit time in the reactor at selected temperatures to remove or reduce reactive carbonyl-containing compounds in the bio-oils including, e.g., organic acids, aldehydes, ketones, or other carbonyl-containing compounds that can form char that can plug or deactivate catalysts in the reactor. In the process, carbonyl-containing compounds are converted to alcohol-containing species and/or ether-containing species, a condition termed “stabilization”. The hydrogenation step may be deemed complete when analysis (e.g., GC-MS analysis) shows carbonyl-containing compounds remaining in the treated bio-oil have a concentration selected below a threshold of about 1% by weight.

Hydrogenated (stabilized) bio-oil may be introduced into a second reactor stage 4 that is pressurized at a selected pressure of hydrogen gas and treated over the bi-functional hydrodeoxygenation catalyst. Flow rate of hydrogen gas may be controlled by mass flow controller 16. Bio-oil may be passed through bi-functional catalyst 8 at a selected temperature. Hydrodeoxygenation may be deemed complete when elemental (e.g., C—H—N—O) analysis shows a concentration of total oxygen below a threshold of 1%. After exiting reactor 4, the product bio-oil 20 may be separated from the gaseous products in a gas-liquid separator 22 placed downstream from reactor 4. Liquid bio-oil product 20 may be recovered, phase-separated, weighed, and/or sampled as needed for analysis. Gaseous products 24 and unreacted hydrogen may be directed to a back-pressure regulator 30 positioned downstream from reactor 4, which maintains pressure in reactors 2 and 4 and separator 22. Gases released from reactor 4 may be collected through a gas sampling port 32 positioned downstream from reactor 4 for subsequent analysis, e.g., in a gas chromatograph, GC-MS, or other analysis instrument. Gas volumes may be measured by passing gases through a gas meter 34 (e.g., a RITTER® wet-test gas flow meter, Calibrated Instruments, Inc., Hawthorne, N.Y., USA). Hydrogen gas consumed in reactors 2 and 4 may be determined as the difference between hydrogen gas fed into the reactors (e.g., mass flow controller 16 reading) and hydrogen gas leaving reactor 4. Two-stage hydrotreating may convert hydrocarbons in the bio-oils into various fuel-range or fuel-suitable hydrocarbons including, e.g., alkanes and cycloalkanes that include a carbon number in the range from about C=3 to about C=18.

### Hydrogenation Catalysts

Hydrogenation catalysts suitable for use in hydrotreating bio-oils in concert with the present invention are non-sulfide-containing (i.e., non-sulfided) catalysts. First stage hydrogenation catalysts may include various metals on various solid metal oxide supports. Catalyst metals may include, but are not limited to: ruthenium (Ru), rhenium (Re), palladium (Pd), platinum (Pt), nickel (Ni), and combinations of these metals. Preferred metal oxide supports may include, e.g., titania (TiO₂), zirconia (ZrO₂), alumina (Al₂O₃), and silica (SiO₂). Solid oxide supports may be impregnated with the selected metal by contacting the metal and solid oxides with an aqueous solution containing the selected metal salt. Once impregnated, the metal may be reduced at a temperature of, e.g., 300° C. in hydrogen gas, which activates the catalyst for use. In the present invention, use of reduced metal catalysts for first step hydrogenation rather than sulfided catalysts minimizes coke formation. Hydrogenation of the present invention promotes hydrogenation activity that successfully competes with condensation reactions that form coke and char.

### Bi-Functional Catalysts

In some embodiments, bi-functional catalysts of the present invention may include a metal on a solid metal oxide support in combination with a solid acid including, e.g., an acidic metal oxide and/or an acid zeolite. In some embodiments, bi-functional catalysts of the present invention may include a metal on a solid acid support including, e.g., an acidic metal oxide and/or an acid zeolite. Metals of the bi-functional catalyst may include, but are not limited to: ruthenium (Ru), rhenium (Re), palladium (Pd), platinum (Pt), nickel (Ni), and combinations of these metals. Solid metal oxide supports of the bi-functional catalyst may include, e.g., titania (TiO₂), zirconia (ZrO₂), alumina (Al₂O₃), and silica (SiO₂). Solid acids or solid acid supports may include, but are not limited to, acidic metal oxides and/or acid zeolites. Acidic metal oxides of the bi-functional catalyst may include, e.g., titania (TiO₂), zirconia (ZrO₂), amorphous silica-alumina (Al₂O₃—SiO₂), niobic acid, tungstic acid, molybdic acid, and combinations of these acid metal oxides. Acid zeolites can include, e.g., Y-zeolites, Beta-zeolites, ZSM-5 zeolites (e.g., H-ZSM-5), Mordenite zeolites, Ferrierite zeolites, Al-MCM-41 zeolites, MCM-48 zeolites, MCM-22 zeolites, SAPO-34 zeolites, Chabazite zeolites, and combinations of these acid zeolites.

In some embodiments, the bi-functional catalyst may include metals on solid supports such as, e.g., palladium (Pd) on carbon (Pd/C); ruthenium (Ru) on carbon (Ru/C); rhodium (Rh) on carbon (Rh/C); ruthenium (Ru) on titania (Ru/TiO₂); ruthenium (Ru) on zirconia (Ru/ZrO₂); and ruthenium (Ru) on an acid zeolite (e.g., H-ZSM-5).

Bi-functional catalysts of the present invention provide a dual function during operation. The metal component catalyzes hydrogenation that saturates double bonds and aromatic rings, and catalyzes hydrogenolysis that cleaves C—O bonds. The acid component increases activity of the metal by catalyzing dehydration that cleaves C—O bonds and C—O—C linkages so that hydrodeoxygenation of compounds in the bio-oil proceeds at lower temperature and hydrogen pressure conditions than required using conventional sulfided catalysts. The present invention upgrades bio-oils at lower operating temperatures and hydrogen pressures that minimize formation of coke that can plug the catalysts in the reactors. Catalysts of the present invention thus have an enhanced activity and a longer reactivity lifetime in the reactor. Further, because sulfur is not present in the catalysts and is not added to the bio-oil, the present invention reduces costs of operation and costs for maintaining capital equipment. The present invention thus provides advantages for hydrotreating bio-oils and producing fuel-suitable hydrocarbons.

### Catalyst Concentrations

In various embodiments, the hydrogenation catalyst may include a metal concentration of from about 0.5% to about 10 wt %, and a solid metal oxide support concentration of between about 90 wt % and about 99.5 wt %

In various embodiments, the bi-functional catalyst may include a metal concentration of from about 0.5% to about 10% by weight. In some embodiments, the metal oxide support may include a concentration of between about 20% and about 90% by weight. In some embodiments, the solid acid may include a concentration of an acidic metal oxide and/or an acid zeolite of between about 10% and about 80% by weight.

In various embodiments, the bi-functional catalyst may include a metal concentration of from about 0.5% to about 10 wt %, a solid acid support concentration of between about 90 wt % and about 99.5 wt %.

### Regeneration of Catalysts

In embodiments that do not employ carbon-supported catalysts, catalysts may be regenerated by oxidation in oxygen (0.5-5% in inert gas; 0.1 to 12.0 MPa) at high temperatures (e.g., 500° C.) to remove any coke formed. In embodiments that employ carbon supports, lower temperatures below about 350° C. may be used.

### Operating Temperatures and Pressures

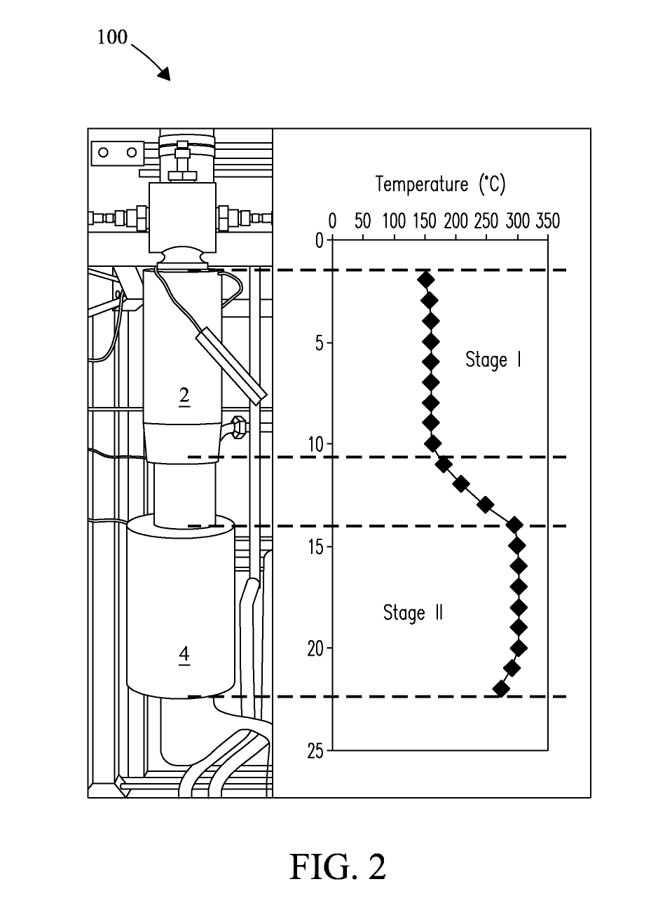

In the first reactor or reactor stage, hydrogenation may be performed at a hydrogen (H₂) gas pressure of from about 3.0 MPa to about 12.0 MPa at a temperature below 200° C. In the second reactor or reactor stage, hydrodeoxygenation may be performed at a hydrogen (H₂) gas pressure of from about 3.0 MPa to about 12.0 MPa at a temperature from about 200° C. to about 400° C. FIG. 2 shows exemplary reaction temperatures employed in the two reactors/reactor stages of FIG. 1.

### Single Stage Reactor Configuration

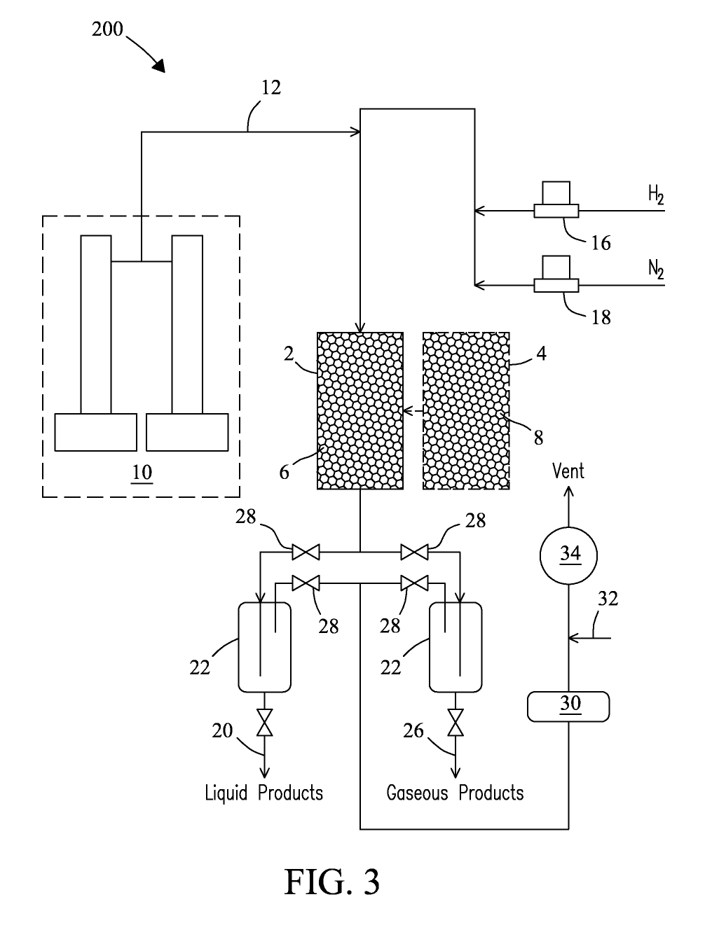

FIG. 3 shows another reactor system 200 of a single-stage design for upgrading bio-oils. System 200 may include a single stage reactor 2 (hydrotreater), e.g., of a fixed-bed type. In some embodiments, reactor 2 may be configured with a single catalyst bed configured with a first hydrogenation catalyst 6. A liquid feed 12 comprising a bio-oil 14 may be fed into reactor 2. Hydrogen gas may be introduced into reactor 2 at a selected flow rate and a selected pressure controlled, e.g., with a mass flow controller 16. Bio-oil may be passed through first catalyst 6 to complete hydrogenation of the bio-oil. Liquid products exiting reactor 2 may be collected in a cooled and pressurized collection vessel 22 and stored. Reactor 2 may be re-charged with hydrogenation catalyst 6 for repeat operation, or may be configured for operation as a second stage reactor 4 as described hereafter.

Hydrogenated bio-oil obtained from first step hydrogenation may be introduced through a single-stage reactor 4 now charged with bi-functional catalyst 8 (or a separate reactor 4 charged with catalyst 8) that is pressurized with a selected pressure of hydrogen gas. Hydrogenated bio-oil may be passed through bi-functional catalyst 8 at a selected temperature to hydrodeoxygenate oxygen-containing compounds in the hydrogenated (stabilized) bio-oil to convert them into fuel-range hydrocarbons including, e.g., C=3 to C=18 alkanes and cycloalkanes. Product bio-oil 20 released from reactor 4 may be collected and separated from gaseous products 26 in a gas-liquid separator 22 downstream from reactor 4.

In some embodiments, system 200 may include a single reactor configured with dual catalyst beds (e.g., catalyst 6 and catalyst 8 in FIG. 1) that are coupled during operation, a first catalyst bed containing a first hydrogenation catalyst and a second catalyst bed containing a second hydrodeoxygenation catalyst. Bio-oil may be fed through the first catalyst to complete hydrogenation of the bio-oil and subsequently through second catalyst to complete hydrodeoxygenation of the bio-oil. System 200 may include other components described previously in reference to FIG. 1. All reactor components and devices as will be selected by those of ordinary skill in the art in view of the disclosure may be used without limitation. System components and devices are not intended to be limited by the description of exemplary embodiments of the present invention.

The following Examples provide a further understanding of the invention.

### EXAMPLE 1

### Preparation of Hydrogenation Catalysts

Hydrogenation catalysts may be prepared by impregnating metal precursor compounds onto metal oxide supports and reducing the metal precursors in hydrogen gas (e.g., 5% hydrogen to 100% hydrogen in an inert gas) at a gas pressure of between about 0.1 MPa to about 12.0 MPa at a temperature of from about 120° C. to about 350° C. Prepared catalysts may include an extrudate size during preparation selected between about 0.20 mm and about 5.0 mm. Prepared catalysts may be used in a first stage or first stage catalyst bed of a two-stage reactor or a single-stage reactor to hydrogenate bio-oils, or to hydrogenate model compounds such as guaiacol in a single stage reactor, as detailed herein. In one example, a ruthenium on titania metal oxide catalyst (3.0% Ru: 97% metal oxide TiO₂) was prepared by impregnating titania (e.g., P25 TiO₂ catalyst, Evonik Industries, Essen, Germany) as the solid metal oxide support with an aqueous solution containing ruthenium (Ru) nitrosyl nitrate as a metal precursor solution. In another example, a ruthenium on zirconia metal oxide catalyst (4.0% Ru: 96% metal oxide ZrO₂) was prepared by impregnating zirconia (e.g., model PP8835 ZrO₂ catalyst, SüdChemie, Muttenz, Switzerland) as the solid metal oxide support with an aqueous solution containing ruthenium (Ru) nitrosyl nitrate as a metal precursor solution, and reducing the metal precursor to the metal in hydrogen gas.

### EXAMPLE 2

### Preparation of Bi-Functional Catalysts

In exemplary tests, catalysts containing an oxide supported metal and a solid acid were used as second step bi-functional catalysts. Bi-functional catalysts were prepared by mixing oxide supported metals catalysts (described in EXAMPLE 1) and solid acid powders at selected mass ratios. As an example, a bi-functional catalyst composed of 3 wt % Ru/TiO₂ and H-ZSM-5 was prepared by physically mixing powders (particle size less than 0.10 mm) of Ru/TiO₂ and H-ZSM-5 (i.e., 50 wt % Ru/TiO₂ and 50 wt % H-ZSM-5) together. Prepared bi-functional catalysts were used to hydrogenate and hydrodeoxygenate bio-oils in a two-stage reactor or to hydrogenate the model compound guaiacol in a single stage reactor.

### EXAMPLE 3

### Hydrogenation and Hydrodeoxygenation of Model Compound Guaiacol

The system of FIG. 3 was used. Hydrodeoxygenation (HDO) experiments were conducted in a lab-scale catalytic hydrotreater of a fixed-bed type constructed of 316 stainless steel with dimensions ½ inch (1.3 cm) internal diameter, a length of 25 inches (63.5 cm), and a capacity of 30 mL. Feed consisted of guaiacol and xylene in a 1:1 molar ratio. Feed was introduced to the reactor system by a high-pressure metering syringe pump. Hydrogen flow rate was controlled by a mass flow controller. Temperatures of the catalyst beds were monitored with thermocouples. Catalysts were treated by flowing pure H₂ at 0.5 MPa from ambient temperature to 300° C. at 0.04° C./s for 2 hrs before initiating the test. Reaction was conducted at a temperature between 160° C. and 280° C. at a hydrogen gas (H₂) pressure of between 1.0 MPa and 3.0 MPa. An initial 5 hr stabilization period at temperature was used to allow the reactor to reach a steady-state condition. Uncondensed gases and liquid sample condensates were collected periodically and analyzed by GC and GC/MS. Space Velocity (SV) of guaiacol (SV_{GUA}, in mol guaiacol/mol metals, based on the total moles of metal) was calculated for each run. Conversion rate constant for guaiacol (k_{GUA}) assumes a first order conversion of guaiacol based on conversion (x_{GUA}) and space velocity (SV_{GUA}) given by Equation [1], as follows:

Rate=k_{GUA}[GUA]; k_{GUA}=−ln(1−x_{GUA})SV_{GUA} [1]

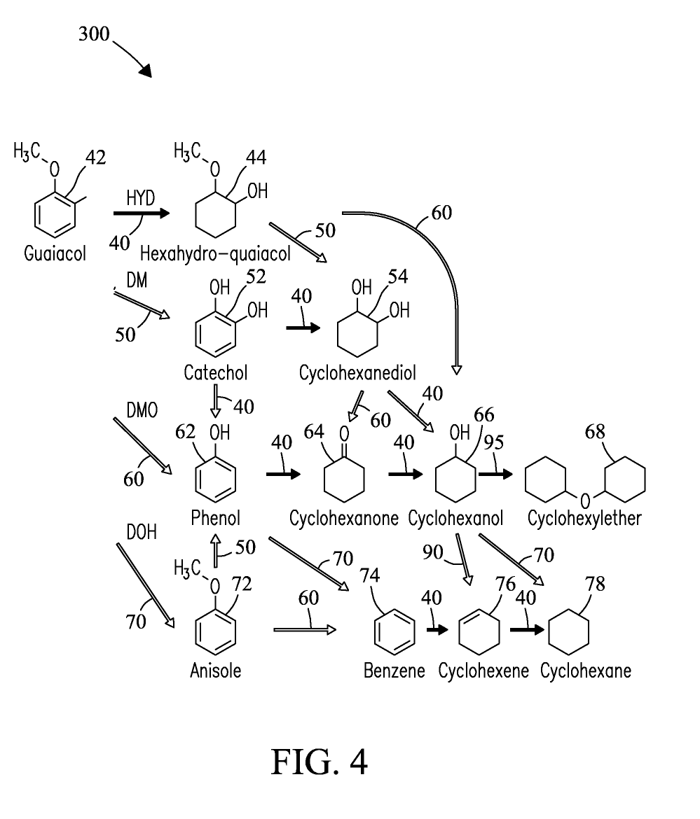

FIG. 4 shows various reaction pathways for conversion of guaiacol 42, a model compound representative of reactive oxygen-containing bio-oil compounds that are converted in the presence of hydrogen to alkane hydrocarbons in accordance with the present invention. In the figure, guaiacol 42 includes dual reactive groups, a methoxy (—O—CH₃) group and a hydroxyl (—OH) group. In some reactions, guaiacol 42 may be converted by a hydrogenation (HYD) reaction 40 in the presence of hydrogen to form hexahydro-guaiacol (HHGUA) 44. HHGUA 44 may be converted further in the presence of hydrogen to cyclohexanol 66 by way of a demethoxylation reaction 60. HHGUA 44 may also proceed by way of a demethylation (DM) reaction 50 in the presence of hydrogen to form cyclohexanediol (CHDO) 54. Conversion of CHDO 54 by dehydration 90 may form cyclohexanone 64. Dehydration reactions accelerate cleavage of C—O bonds that remove oxygen from the bio-oil. Conversion of CHDO 54 may also proceed by way of a dehydroxylation (DOH) reaction 70 to form cyclohexanol 66. In some reactions, guaiacol 42 may proceed in the presence of hydrogen by way of a demethylation (DM) reaction 50 to form catechol 52. Conversion of catechol 52 may proceed by hydrogenation reaction 40 to form cyclohexanediol (CHDO) 54. Further conversion of (CHDO) 54 may proceed as described previously above to form cyclohexanol 66. In some reactions, hydrogenation (HYD) 40 of guaiacol 42 may proceed in the presence of hydrogen by way of a demethoxylation (DMO) reaction 60 to form phenol 62. In some reactions, phenol 62 may proceed by way of a further hydrogenation reaction 40 to form cyclohexanone 64 and ultimately to form cyclohexanol 66. In some reactions, hydrogenation (HYD) 40 of guaiacol 42 may include a dehydroxylation reaction 70 to form anisole 72. In some reactions, anisole 72 may convert by way of a demethylation reaction 50 to form phenol 62. Alternatively, phenol 62 may proceed by hydrogenation reaction 40 to form cyclohexanol 66 as described previously. In some reactions, anisole 72 may proceed by way of a demethoxylation reaction 60 to form benzene 74. Oxygen-containing compounds (e.g., alcohols and ethers) and unsaturated hydrocarbons may be subsequently converted into saturated hydrocarbons such as cyclohexane 78.

### EXAMPLE 4

### First Step Hydrogenation: Conversion of Guaiacol on Carbon-Supported Metal Catalysts

The system of FIG. 1 was used. Guaiacol was mixed with xylene in a 1:1 molar ratio. TABLE 2 lists products resulting from HDO conversion of guaiacol in concert with selected catalysts at 240° C. at a hydrogen (H₂) pressure of 3.0 MPa, guaiacol conversion values, conversion rate constants, and product selectivities.

TABLE 2
Guaiacol conversion, conversion rate constant, and product selectivity on different
catalysts at 240° C., 3.0 MPa H₂ and the H₂ to feed ratio of 5000 L/L.

| | | | | Selectivity (%)^{b} | | | | | |
|---|---|---|---|---|---|---|---|---|---|
| | GUA | | | Phenol + | | | | | |
| Catalyst | conversion | SV_{GUA}^{a} | k_{GUA}^{a} | Anisole | HHGUA | CHDO | CHO | CH | HMW |
| Ru/C | 59% | 0.047 | 0.042 | 1.1 | 63.7 | 0.4 | 29.1 | 5.3 | 0.4 |
| (0.7%) | | | | | | | | | |
| Pd/C | 87% | 0.018 | 0.036 | 1.1 | 76.4 | 0 | 3.7 | 11.8 | 6.8 |
| (1.5%) | | | | | | | | | |
| Pt/C | 15% | 0.078 | 0.013 | 1.9 | 92.3 | 0 | 5.7 | 0.2 | 0 |
| (0.5%) | | | | | | | | | |
| Re/C | 2.7% | 0.013 | 0.00035 | 78.8 | 2.7 | 0 | 6 | 12.6 | 0 |
| (5.0%) | | | | | | | | | |

^{a}in mol GUA/(mol metal s)
^{b}HHGUA: hexahydro-guaiacol, CHDO: 1,2-cyclohexanediol; CHO: cyclohexanol; CH: cyclohexane; HMW: high molecular weight products.

Ru/C (0.7%), Pd/C (1.5%), Pt/C (0.5%), and Re/C (5.0%) were commercially obtained catalysts. Results show that the ruthenium (Ru) on carbon (C) catalyst (Ru/C) [i.e., Ru/C (0.7%)] has the highest rate constant. The palladium (Pd) on carbon (C) catalyst (Pd/C) [i.e., Pd/C (1.5%)] shows a slightly lower rate constant than the Ru/C (0.7%) catalyst. Formation of hydrogenated products (˜96-99% selectivity), including HHGUA, CHDO, CHO, and CH are predominant conversion products on ruthenium (Ru), palladium (Pd), and platinum (Pt) catalysts, indicating a preference of the hydrogenation (HYD) route for conversion of guaiacol. Preferential formation of phenol and anisole (˜79% selectivity) was observed on the rhenium (Re) catalyst. However, conversion rate is approximately two orders of magnitude lower than that observed for the ruthenium (Ru), palladium (Pd), and platinum (Pt) catalysts. Selectivity of cyclohexanol on Ru/C (0.7%) was much higher than Pd/C (1.5%) even at a lower conversion, indicating a faster C—O bond cleavage on ruthenium (Ru) metal compared with palladium (Pd) metal. Results show ruthenium (Ru) metal possesses good hydrogenation activity and oxygen removal ability suitable for use as an HDO catalyst for conversion of oxygen-containing compounds to hydrocarbons.

### EXAMPLE 5

### Hydrogenation Catalysts: Conversion of Guaiacol on Ruthenium Supported Catalysts

The system of FIG. 2 was used. Guaiacol was mixed with xylene in a 1:1 molar ratio. TABLE 3 compares conversion results of guaiacol on various ruthenium (Ru) metal catalysts on different supports.

TABLE 3
Guaiacol conversion, conversion rate constant, and product selectivity on different
catalysts at 200° C., 3.0 MPa H₂ and the H₂ to feed ratio of 5000 L/L.

| | | | Selectivity (%) ^{b} | | | | | |
|---|---|---|---|---|---|---|---|---|
| | GUA | | Phenol + | | | | | |
| Catalyst | conv. | SV_{GUA}^{a} | Anisole | HHGUA | CHDO | CHO | CH | HMW |
| Ru/ZrO₂ | 99% | 0.0025 | 0 | 30.6 | 1.1 | 67.4 | 0.8 | 0 |
| (5.0%) | | | | | | | | |
| Ru/C | 100% | 0.0026 | 0 | 50.1 | 6.2 | 33.2 | 6.8 | 3.7 |
| (6.0%) | | | | | | | | |
| Ru/TiO₂ (3.0% | 100% | 0.0026 | 0 | 0.6 | 3.4 | 44.2 | 48.5 | 0 |
| commercial) | | | | | | | | |
| Ru/TiO₂ (3.0% | 100% | 0.014 | 0 | 7.9 | 19.3 | 62.5 | 5.6 | 3.5 |
| commercial) | | | | | | | | |
| Ru/TiO₂ | 99% | 0.014 | 0 | 0.6 | 0.1 | 32.8 | 66.4 | 0 |
| (3.0%, prepared) | | | | | | | | |
| Ru/ZrO₂ | 100% | 0.014 | 0 | 6.8 | 6.8 | 60.2 | 26.2 | 0 |
| (4.0%) | | | | | | | | |

^{a}in mol GUA/(mol metal s)
^{b} HHGUA: hexahydro-guaiacol, CHDO: 1,2-cyclohexanediol; CHO: cyclohexanol; CH: cyclohexane; HMW: high molecular weight products.

Data in TABLE 3 show guaiacol conversion values, conversion rate constants, and product selectivities on different catalysts at 240° C. at a hydrogen (H₂) pressure of 3.0 MPa and a H₂ to feed ratio of 5000 L/L. Ru/ZrO₂ (5.0%), Ru/C (6.0%), and Ru/TiO₂ (3.0% commercial) were commercially obtained catalysts. Ru/TiO₂ (3.0%, prepared) and Ru/ZrO₂ (4.0%, prepared) were prepared by an impregnation method described in EXAMPLE 1. Results show complete conversion of guaiacol on all catalysts. The Ru/TiO₂ (3.0%, prepared) showed the highest cyclohexane selectivity and the lowest selectivity of oxygen-containing products (HHGUA, CHDO, and CHO) and highest selectivity of CH, indicating the best performance among the catalysts tested.

### EXAMPLE 6

### Second Step Bi-Functional Catalysts: Conversion of Guaiacol

The system of FIG. 1 was used. The conversion of Guaiacol was tested using metal supported catalysts against bi-functional catalysts comprising a metal supported catalyst and a solid acid. Guaiacol was mixed with xylene in a 1:1 molar ratio. TABLE 4 compares guaiacol conversion results using single metal supported catalysts and bi-functional catalysts.

TABLE 4
compares guaiacol conversion results, conversion rate constants, and product selectivities for different
catalysts at 200° C., 3.0 MPA H₂ and the H₂ to feed ratio of 5000 L(H₂)/L(feed A).

| | | | | Selectivity (%) ^{b} | | | | | |
|---|---|---|---|---|---|---|---|---|---|
| | | GUA | | Phenol + | | | | | |
| Catalyst | T (C.) | conv. | SV_{GUA}^{a} | Anisole | HHGUA | CHDO | CHO | CH | HMW |
| Pd/C (2.5%) | 200 | 14% | 0.016 | 0 | 74.5 | 0 | 6.6 | 4.7 | 18 |
| Pd/C (2.5%) + ZrO₂ | 200 | 90% | 0.016 | 0 | 77.0 | 0 | 5.5 | 5.1 | 15 |
| Pt/C (0.5%) | 240 | 15% | 0.078 | 1.9 | 92.3 | 0 | 5.7 | 0.2 | 0 |
| Pt/C (0.5%) + ZrO₂ | 240 | 58% | 0.078 | 1.2 | 87.4 | 0.4 | 9.6 | 0.4 | 0.5 |
| Ru/C (6.0%) | 200 | 100% | 0.0026 | 0 | 50.1 | 6.2 | 33.2 | 6.8 | 3.7 |
| Ru/C (6.0%) + ZrO₂ | 200 | 100% | 0.0026 | 0 | 8.5 | 13.3 | 73.1 | 9.0 | 2.3 |
| Ru/TiO₂ (3.0% | 200 | 100% | 0.0026 | 0 | 0.6 | 3.4 | 44.2 | 48.5 | 0 |
| commercial) | | | | | | | | | |
| Ru/TiO₂ (3.0% | 200 | 100% | 0.0025 | 0 | 0 | 0 | 0 | 100 | 0 |
| commercial) + ZrO₂ | | | | | | | | | |

^{a}in mol GUA/(mol metal s)
^{b} HHGUA: hexahydro-guaiacol, CHDO: 1,2-cyclohexanediol; CHO: cyclohexanol; CH: cyclohexane; HMW: high molecular weight products.

Results show conversion may be enhanced by combining the metal supported catalyst with a solid acid. Pd/C (2.5%), Pt/C (0.5%), Ru/C (6.0%), and Ru/TiO₂ (3.0%) were commercially obtained catalysts. Zirconium oxide (ZrO₂) (Degussa, Evonik Industries, Essen, Germany) is a representative acidic oxide with an acid function that promotes activity of metal-containing catalysts. All bi-functional catalysts were prepared by combining a supported metal and a solid acid using a physical mixing method described previously in EXAMPLE 2. Conversion of guaiacol increases from about 14% to about 90% by addition of ZrO₂ to the Pd/C (2.5%) catalyst, and from about 15% to about 58% by addition of ZrO₂ to the Pt/C (0.5%) catalyst. Selectivity for the deoxygenation product CHO also increases from about 33% to about 73% by addition of ZrO₂ to the metal-supported Ru/C (6.0%) catalyst. Selectivity for the deoxygenation product CH product also increases from about 48.5% to about 100% by addition of ZrO₂ to a Ru/TiO₂ (3.0%, commercial) catalyst. The acidic metal oxide enhances the HDO activity of supported precious metal catalysts. Results confirm the promotional effect of a solid acid (e.g., acidic oxide) on the HDO activity of supported metal catalysts.

### EXAMPLE 7

### Second Step Bi-Functional Catalysts: Conversion of Guaiacol

The system of FIG. 1 was used. Guaiacol (GUA) was mixed with xylene in a 1:1 molar ratio. TABLE 5 compares guaiacol conversion results using single metal supported catalysts and bi-functional catalysts.

TABLE 5
compares guaiacol conversion results, conversion rate constants, and
product selectivities for different catalysts at 200° C., 3.0 MPA H₂,
a space velocity of 0.014 mol GUA/(moL metal s) and the H₂ to feed ratio of
5000 L(H₂)/L(feed A).

| | | Selectivity (%) ^{a} | | | | | |
|---|---|---|---|---|---|---|---|
| | GUA | Phenol + | | | | | |
| Catalyst | conv. | anisole | HHGUA | CHDO | CHO | CH | HMW |
| Ru/TiO₂ (3.0% | 99% | 0 | 7.9 | 19.3 | 62.5 | 5.6 | 3.5 |
| commercial) | | | | | | | |
| Ru/TiO₂ (3.0% | 100% | 0 | 2.0 | 4.6 | 72.7 | 19.6 | 1.0 |
| commercial) + | | | | | | | |
| ZrO₂ | | | | | | | |
| Ru/TiO₂ (3.0% | 99% | 0 | 4.8 | 17.6 | 63.9 | 6.7 | 5.2 |
| commercial) + | | | | | | | |
| TiO₂ | | | | | | | |
| Ru/TiO₂ (3.0% | 100 | 0 | 0 | 0 | 0 | 70 | 30 |
| commercial) + | | | | | | | |
| sFCC | | | | | | | |
| Ru/TiO₂ (3.0% | 100% | 0 | 0 | 0 | 0 | 99.7 | 0.3 |
| commercial) + | | | | | | | |
| H-ZSM5 | | | | | | | |
| Ru/TiO₂ (3.0%, | 100% | 0 | 0.6 | 0.1 | 32.8 | 66.4 | 0 |
| prepared) | | | | | | | |
| Ru/TiO₂ (3.0%, | 100% | 0 | 0.2 | 0 | 1.9 | 97.9 | 0 |
| prepared) + | | | | | | | |
| H-ZSM5 | | | | | | | |

^{a} HHGUA: hexahydro-guaiacol, CHDO: 1,2-cyclohexanediol; CHO: cyclohexanol; CH: cyclohexane; HMW: high molecular weight products.

All bi-functional catalysts were prepared by combining a supported metal and a solid acid using the physically mixing method described in EXAMPLE 2. In TABLE 5, complete conversion of guaiacol is observed for all catalysts. Product selectivities vary. Ru/TiO₂ (3.0%, commercial), TiO₂, spent fluidized catalytic cracking catalyst (sFCC), and H-ZSM-5 were obtained commercially (BASF Corp., Iselin, N.J., USA). Ru/TiO₂ (3.0%, prepared) was prepared by an impregnation method described in EXAMPLE 1. Conversion of guaiacol on Ru/TiO₂ (3.0%, commercial) catalysts produced cyclohexanol (63%) and cyclohexanediol (20%), and lesser concentrations of other compounds. Cyclohexane (6%) was a final product. After addition of the acidic metal oxide ZrO₂, cyclohexanediol (selectivity of 5%) was converted to cyclohexanol. Cyclohexanol was converted to cyclohexane (selectivity of 20%). Titania (TiO₂) as the acidic metal oxide did not promote conversion of alcohols to hydrocarbons. Ru/TiO₂ (3.0%, commercial) with a spent fluid catalytic cracking (sFCC) catalyst converted all reactants to hydrocarbons, but with a higher selectivity toward unknown high-molecular-weight (non-fuel range) products.

Ru/TiO₂ (3.0%, commercial) (metal on metal oxide support catalyst) combined with H-ZSM5 (acid zeolite) showed nearly (within ±2%) 100% conversion of guaiacol to cyclohexane. H-ZSM5 enhanced activity better than other solid acids including ZrO₂, TiO₂, and sFCC. Ru/TiO₂ (3.0% prepared) with H-ZSM5 also showed nearly 100% conversion of guaiacol to cyclohexane.

Results with model compounds indicate that Ru/TiO₂ (3.0%, prepared) has a best hydrogenation activity of those tested. As a bi-functional catalyst, Ru/TiO₂ (3.0%, prepared) when combined with H-ZSM5 has a best oxygen removal (i.e., HDO) activity, as described in further tests hereafter.

### EXAMPLE 10

### Two-Step Hydrotreating of Non-Catalytic Pinewood Bio-Oil in a Single-Stage Reactor

TABLE 9
Reaction conditions of the separated two-step hydrotreating of
non-catalytic bio-oil [A].

| | First Step | Second Step |
|---|---|---|
| Catalyst | Ru/TiO₂ (3.0%, | Ru/TiO₂ (3.0%, prepared) + |
| | prepared) | H-ZSM-5 |
| LHSV (L/L h) | 0.80 | 0.20 |
| H2/Feed (L/L) | 3124 | 5000 |
| Pressure (MPa) | 8.0 | 8.0 |
| Temperature (° C.) | 160 | 280 |

TABLE 9 lists conditions for the separated two step hydrotreating of non-catalytic bio-oil [A]. Results are listed in TABLE 10 including yields of oil, aqueous products, and gaseous products, the properties (elemental composition, water content, density, and GC-MS results) of organic liquid products, and H₂ consumption. After the first step hydrogenation in a single stage reactor using Ru/TiO₂ (3.0%, prepared) catalyst, the bio-oil was converted to a single-phase stabilized bio-oil with an overall yield of 101 wt % for the 32 hour experiment. The stabilized bio-oil has a lower density (from 1.20 to 1.14 g/ml) and higher water content (from 11.0 to 14.3%) than the bio-oil feedstock, indicating that the deoxygenation occurred during step 1 treatment. The dry basis yield (yield of dry product based on dry feed) is 97.4%, consistent with the occurrence of deoxygenation. The stabilized bio-oil was homogenous and the GC-MS analysis showed the major components of C1-C6 alcohols, acetic acid, and guaiacols with a carbon number over 8. H/C ratio increased from 1.44 to 1.78 and oxygen content decreased from 34.5 to 31.7 after the step 1 hydrogenation, indicating the major reaction was hydrogenation with minor deoxygenation reaction.

TABLE 10
Results from separated two-step hydrotreating of non-catalytic bio-oil [A].

| | Bio-oil or final fuels | | | | | | | | |
|---|---|---|---|---|---|---|---|---|---|
| | Dry basis | | | | | | | Gaseous | |
| | | | O | | | Aqueous phase | | product | H₂ used |
| | Yield | H/C | content | Density | H₂O | Yield (wet | H₂O | yield dry | (g/g dry |
| | (%) | ratio | (wt. %) | (g/ml) | (%) | basis, %) | (%) | basis (%) | feed) |
| Bio-oil feed | — | 1.44 | 34.5 | 1.20 | 11.0 | — | — | — | — |
| (non-catalytic | | | | | | | | | |
| bio-oil A) | | | | | | | | | |
| After first step | 97.4 | 1.78 | 31.7 | 1.14 | 14.3 | — | — | 0 | 0.015 |
| (TOS: 0-32 h) | | | | | | | | | |
| After second | 51.0 | 1.77 | 7.2 | 0.92 | 1.0 | 38.8 | 94.0 | 27.1 | 0.053 |
| step | | | | | | | | | |
| (TOS: 28-32 h) | | | | | | | | | |

After the first step hydrogenation, the stabilized non-catalytic bio-oil [A] was treated by a second step hydrodeoxygenation in a single stage reactor using a second step catalyst of Ru/TiO₂ (3.0%, prepared)+H-ZSM-5. Hydrodeoxygenation of oxygen-containing compounds in the bio-oil occurred during the second step treatment. During the 42 h experiment at 280° C. and 8.0 MPa, no indication of plugging of the reactor was observed. Liquid products obtained following the reaction had two phases, an organic phase at the top of the liquid containing the final bio-oil product fuels and aqueous phase at the bottom. Gaseous products including CH₄, C₂H₆, C₃H₈, and C₄H₁₀ were also detected in the outlet gas. The yield of gaseous products decreased and the yield of final oil increased at 0-20 h and then leveled off at 20-42 hrs. TABLE 10 lists detailed analysis results of the products at a TOS of 28 hrs to 32 hrs. Oxygen content in the organic product was 7.2 wt %, the density of the organic product was 0.92 g/mL, and the water content in the final fuel product was 1.0 wt %. Removal of oxygen was achieved and the oxygen content decreased from 34.6% in the feed to 7.2% in the product. GC-MS analysis showed the final bio-oil product contained alkanes, cycloalkanes, and minor alcohols (<1 wt %).

### EXAMPLE 10

### Two-Step Hydrotreating of Catalytic Bio-Oil from Pinewood Biomass in Single-Stage Reactor

In another test, catalytic bio-oil [A] was treated by the separated two-step hydrotreating process. TABLE 11 lists reaction conditions.

TABLE 11
Reaction conditions for the separated two-step hydrotreating of
catalytic bio-oil [A].

| | First Step | Second Step |
|---|---|---|
| Catalyst | Ru/TiO₂ (3.0%, | Ru/TiO₂ (3.0%, prepared) + |
| | prepared) | H-ZSM-5 |
| LHSV (L/L h) | 0.80 | 0.20 |
| H₂/Feed (L/L) | 3124 | 5000 |
| Pressure (MPa) | 8.0 | 8.0 |
| Temperature (° C.) | 160 | 280, 320 |

First step hydrogenation was performed in a single stage reactor using Ru/TiO₂ (3.0%, prepared) catalyst. Hydrogenation converted ketones, aldehydes, and light phenols in the bio-oil to alcohols. Density of the oil decreased from 1.11 to 1.03 g/ml, and water content increased from 18.0 to 20.1%. The stabilized catalytic bio-oil [A] was then treated in a single stage reactor using a bi-functional catalyst Ru/TiO₂ (3.0%, prepared)+H-ZSM-5 at a temperature between 280° C. and 320° C. and a pressure of 8.0 MPa for 40 hrs. No plugging of the reactor was observed. Liquid products obtained following the reaction included two phases, an organic phase at the top of the liquid containing the final fuel range hydrocarbons and an aqueous phase at the bottom of the liquid. Gaseous products were also detected in the outlet gas including CH₄, C₂H₆, C₃H₈, and C₄H₁₀. TABLE 12 lists results.

TABLE 12
Results of the separated two-step hydrotreating of catalytic bio-oil A.

| | | | | | | | | Gaseous | |
|---|---|---|---|---|---|---|---|---|---|
| | Final fuel or bio-oil | | | | | Aqueous phase | | product | |
| | Dry basis | | | | | Yield | | yield dry | H₂ used |
| | Yield | | O | Density | H₂O | (%, wet | H₂O | basis | (g/g dry |
| | (%) | H/C | (wt. %) | (g/ml) | (%) | basis) | (%) | (%) | feed) |
| Bio-oil feed | — | 1.26 | 31.1 | 1.11 | 18.0 | — | — | — | — |
| (Catalytic | | | | | | | | | |
| bio-oil A) | | | | | | | | | |
| After first step | 95.4 | — | — | 1.03 | 20.1 | — | — | 0.2 | 0.028 |
| After second | 68.0 | 1.75 | 5.2 | 0.91 | 0.80 | 30.1 | 91.5 | 23.8 | 0.044 |
| step at 280° C. | | | | | | | | | |
| (TOS: 28-32 h) | | | | | | | | | |
| After second | 54.5 | 1.81 | 1.4 | 0.88 | 0.15 | 36.9 | 98.5 | 27.7 | 0.052 |
| step at 320° C. | | | | | | | | | |
| (TOS: 36-40 h) | | | | | | | | | |

Results show that oxygen content (dry basis) in the final fuel obtained at 280° C. is 5.2%, density of the final fuel is 0.91 g/mL, and water content in the final fuel is 0.80 wt %. GC-MS analysis showed that the final fuel consisted of alkanes, cycloalkanes, and minor alcohols and aromatics (<2 wt %). An increase in reaction temperature from 280° C. to 320° C. decreased organic yield from 68% to 54% (dry weight basis), decreased the density of the organic product from 0.91 g/mL to 0.88 g/mL, and decreased oxygen content of the organic product from 5.2% to 1.4%. The higher temperature enhances conversion of bio-oil to final fuels and achieves a lower oxygen content (<2 wt %). Results indicate that hydrogenation of small ketones, aldehydes, and phenols and partial acetic acids occurs during step 1 hydrogenation at 160° C. using Ru/TiO₂ (prepared) catalyst, which greatly improves the thermochemical stability of the bio-oil because reactive aldehydes and ketones are removed. Second step hydrodeoxygenation of step-1 hydrogenated, stabilized bio-oil using a prepared bi-functional catalyst such as Ru/TiO₂+H-ZSM-5 produces a final oil at a preferred temperature of 320° C. with an oxygen content below 2 wt %.

### EXAMPLE 11

### Hydrotreating of Catalytic Bio-Oil from Pinewood Biomass by an Integrated Two-Step Hydrotreating Process using a Two-Stage Reactor

In other tests, catalytic bio-oil [B] was treated by an integrated two-step hydrotreating process in a two-stage reactor having two heating zones. First step catalyst Ru/TiO₂ (3.0%, prepared) was loaded in the first stage and second step bi-functional catalyst Ru/TiO₂ (3.0%, prepared)+H-ZSM-5 was loaded in the second stage of the two-stage reactor. TABLE 13 lists reaction conditions.

TABLE 13
Reaction conditions of the integrated two-step hydrotreating of
catalytic bio-oil [B].

| | First Step | Second Step |
|---|---|---|
| Catalyst | Ru/TiO₂ (3.0%, | Ru/TiO₂ (3.0%, prepared) + |
| | prepared) | H-ZSM-5 |
| LHSV (L/L h) | 0.30 | 0.20 |
| H₂/Feed (L/L) | 5000 | 5000 |
| Pressure (MPa) | 12.0 | 12.0 |
| Temperature (° C.) | 160 | 320 |

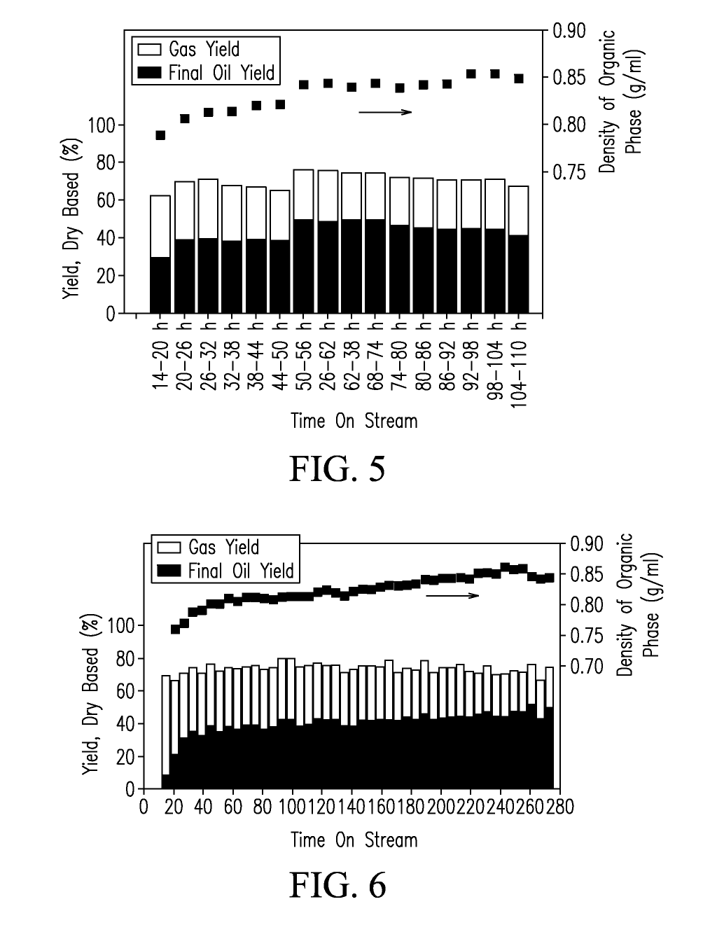

FIG. 5 shows yields of product gases and product bio-oil and density of the product bio-oil resulting from two-stage hydrotreatment of a raw catalytic bio-oil in the two-stage reactor as a function of time on stream. TABLE 14 lists results of the integrated two-step hydrotreating process, including the density of the final oil and gas yields as a function of time on stream (TOS).

TABLE 14
Results of the integrated two-step hydrotreating of catalytic bio-oil B.

| | | Final fuel or bio-oil | | | Aqueous phase | | Gaseous | |
|---|---|---|---|---|---|---|---|---|
| | | Yield | | | Yield | | product | H₂ used |
| | | (%, dry | Density | H₂O | (%, wet | H₂O | yield (%, | (g/g dry |
| | | basis) | (g/ml) | (%) | basis) | (%) | dry basis) | bio-oil) |
| Bio-oil feed (catalytic | | — | 1.12 | 40.7 | — | — | — | — |
| bio-oil B) | | | | | | | | |
| After | TOS 26-32 h | 39.3 | 0.813 | 0.0 | 57.2 | 100 | 31.7 | 0.088 |
| two step | TOS 50-56 h | 49.4 | 0.842 | 0.0 | 57.6 | 100 | 26.4 | 0.092 |
| process | TOS 74-80 h | 46.2 | 0.839 | 0.0 | 64.1 | 100 | 25.5 | 0.095 |
| | TOS 98-104 h | 44.3 | 0.854 | 0.0 | 61.6 | 100 | 26.6 | 0.084 |

Resulting liquid products had two phases, an organic phase at the top of the liquid containing the final fuel range hydrocarbons, and an aqueous phase at the bottom of the liquid. Gaseous products detected in the outlet gas included methane (CH₄), ethane (C₂H₆), propane (C₃H₈), and butane (C₄H₁₀). As shown in TABLE 14 and FIG. 5, the reaction reached a steady-state at a TOS of ˜20 hrs.

The final yield of fuel range hydrocarbons (about 45-50%, dry basis), the density of final oil (around 0.85 g/ml), and the H₂ consumption (around 0.09 H₂ per g dry bio-oil) were constant over the TOS of from 50 hrs to 108 hrs. No organics were found in the aqueous product.

### EXAMPLE 12

### Hydrotreating of Non-Catalytic Bio-Oil from Pinewood Biomass in an Integrated Two-Step Hydrotreating Process in a Two-Stage Reactor

In other tests, a non-catalytic bio-oil B was treated by an integrated two-step hydrotreating process in a two-stage reactor having two heating zones. First step catalyst Ru/TiO₂ (3.0%, prepared) was loaded in the first stage and second step bi-functional catalyst Ru/TiO₂ (3.0%, prepared)+H-ZSM-5 was loaded into the second stage of the two stage reactor. TABLE 15 lists reaction conditions.

TABLE 15
Reaction conditions for the integrated two-step hydrotreating of
non-catalytic bio-oil [B].

| | First Step | Second Step |
|---|---|---|
| Catalyst | Ru/TiO₂ (3.0%, | Ru/TiO₂ (3.0%, prepared) + |
| | prepared) | H-ZSM-5 |
| LHSV (L/L h) | 0.16 | 0.15 |
| H₂/Feed (L/L) | 6667 | 6667 |
| Pressure (MPa) | 12.0 | 12.0 |
| Temperature (° C.) | 160 | 320 |

FIG. 6 shows yields of product gases and product bio-oil, and the density of the product bio-oil as a function of time on stream. Results show 276 hours of stable reactor operation was achieved with no plugging. No char (coke) formation was observed in the reactor. The resulting liquid products had two phases, an organic phase at the top of the liquid containing the final fuels and an aqueous phase at the bottom of the liquid. Gaseous products in the outlet gas were detected including CH₄, C₂H₆, C₃H₈, and C₄H₁₀. TABLE 16 lists results of the integrated two-step hydrotreating of non-catalytic bio-oil [B].

TABLE 16
Results for the integrated two-step hydrotreating of non-catalytic bio-oil [B].

| | | | | | | | | | | Gaseous | |
|---|---|---|---|---|---|---|---|---|---|---|---|
| | | Final oil or bio-oil | | | | | | Aqueous phase | | product | |
| | | Dry basis | | | | | TAN | Yield | | yield dry | H₂ used |
| | | Yield | | O | Density | H₂O | (mg | (%, wet | H₂O | basis | (g/g dry |
| | | (%) | H/C | (wt. %) | (g/ml) | (%) | KOH/g) | basis) | (%) | (%) | feed) |
| Bio-oil feed (non- | | — | 1.38 | 34.9 | 1.20 | 15.3 | ~105 | — | — | — | — |
| catalytic bio-oil B) | | | | | | | | | | | |
| After | TOS 24-30 h | 31.2 | — | — | 0.770 | 0.0 | — | 44.2 | 100 | 39.5 | 0.105 |
| two step | TOS 54-60 h | 38.4 | — | — | 0.810 | 0.0 | — | 44.7 | 100 | 36.0 | 0.106 |
| process | TOS 90-96 h | 42.5 | 1.93 | 0.56 | 0.813 | 0.0 | 0.05 | 47.0 | 100 | 37.2 | 0.114 |
| | TOS 138-144 h | 38.1 | 1.95 | 0.56 | 0.822 | 0.0 | 0.01 | 48.2 | 100 | 34.8 | 0.089 |
| | TOS 192-198 h | 42.5 | 1.86 | 0.71 | 0.840 | 0.0 | 0.01 | 46.6 | 100 | 28.5 | 0.102 |
| | TOS 240-246 h | 44.1 | 1.82 | 1.27 | 0.861 | 0.0 | 0.08 | 43.5 | 100 | 26.5 | 0.101 |
| | TOS 264-270 h | 43.0 | 1.84 | 1.52 | 0.842 | 0.0 | 0.18 | 44.1 | 100 | 23.5 | 0.092 |

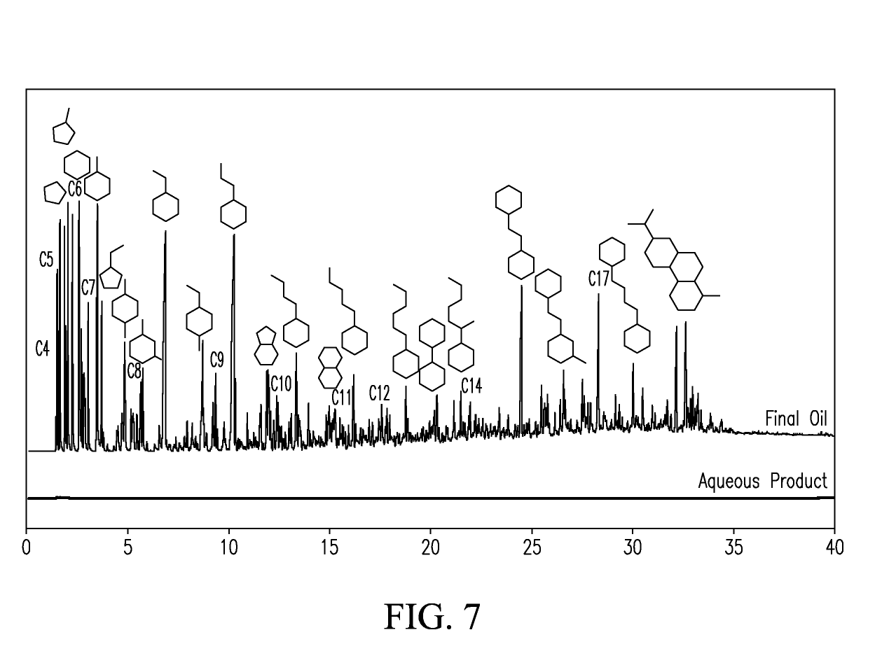

As shown in the TABLE 16 and FIG. 6, yield of final fuel-range hydrocarbons (dry basis) was around 38-44%, the yield of gaseous products (dry basis) was around 26-36%, the density of final oil was around 0.80-0.85 g/ml, the oxygen content (dry basis) of the final oil was about 0.5-1.5%, and the H/C ratio of final oil (dry basis) was around 1.85-1.95, indicating a significant removal of oxygen from the bio-oil of from about 35% down to <1.5%). TABLE 17 lists the composition of gaseous products for the two-stage hydrotreatment of the non-catalytic bio-oil. FIG. 7 shows a GC-MS spectrum of compounds in the final product oil phase and the aqueous product phase resulting at a time on stream of between 126 hrs. and 132 hrs.

TABLE 17
Composition of gaseous products for the integrated two-step
hydrotreating of non-catalytic bio-oil [B].

| Time-on-Stream | Gaseous product composition (wt %) | | | | |
|---|---|---|---|---|---|
| (hrs) | CH₄ | C₂H₆ | C₃H₈ | C₄H₁₀ | C₅H₁₂ |
| 24-30 | 64.1 | 10.4 | 12.5 | 8.5 | 4.5 |
| 54-60 | 67.9 | 11.0 | 10.9 | 7.5 | 2.8 |
| 90-96 | 66.8 | 10.9 | 10.8 | 8.0 | 3.5 |
| 138-144 | 67.5 | 9.7 | 11.8 | 7.7 | 3.2 |
| 192-198 | 63.2 | 10.7 | 13.9 | 8.4 | 3.8 |
| 240-246 | 60.1 | 12.6 | 13.5 | 9.7 | 4.0 |
| 264-270 | 54.5 | 13.9 | 15.8 | 10.9 | 4.9 |

As shown in FIG. 7 and TABLE 17, the gaseous product includes C1-C5 alkanes. The final oil includes C4-C17 alkanes and cycloalkanes and no detectable organic is observed in the aqueous phase, indicating a production of high quality fuel-range hydrocarbons. Similar products are observed at different TOS values. Conventional sulfided catalysts have a limited lifetime of around 100 hours. Results show the catalyst of the present invention has a much greater stability than conventional sulfided catalysts for upgrading non-catalytic bio-oils. Catalysts of the present invention may begin to deactivate gradually after a time-on-stream (TOS) of about 140 hrs currently. However, full operation lifetimes are greater than those of conventional catalysts by over 40 hrs on average. Even during periods of gradual catalyst decline, e.g., from TOS of 140 h to 240 h, density of the organic product may increase only from about 0.82 g/mL to about 0.86 g/mL. And, oxygen content in the final bio-oil may increase only from about 0.5% to about 1.3%.

While exemplary embodiments of the present invention have been shown and described, it will be apparent to those skilled in the art that many changes and modifications may be made without departing from the invention in its true scope and broader aspects. The appended claims are therefore intended to cover all such changes and modifications as fall within the scope of the present invention.

What is claimed is:

1. A process for upgrading a bio-oil, comprising:
hydrodeoxygenating the bio-oil in the presence of a bi-functional catalyst comprising a metal on a solid support and a solid acid; or a metal on a solid acid support at a hydrogen pressure and a temperature selected to form a product bio-oil comprising fuel-range hydrocarbons.

2. The process of claim 1, wherein the fuel-range hydrocarbons include alkanes and cycloalkanes with a carbon number from about C=3 to about C=18.

3. The process of claim 1, wherein the metal is selected from the group consisting of: Ruthenium (Ru), Rhenium (Re), Palladium (Pd), Platinum (Pt), Nickel (Ni), and combinations thereof.

4. The process of claim 1, wherein the solid support is a metal oxide.

5. The process of claim 1, wherein the solid acid or the solid acid support is selected from the group consisting of: acidic metal oxides, acid zeolites, and combinations thereof.

6. The process of claim 5, wherein the acidic metal oxide is selected from the group consisting of: titania (TiO₂), zirconia (ZrO₂), amorphous silica alumina (Al₂O₃—SiO₂), niobic acid, tungstic acid, molybdic acid; and combinations thereof.

7. The process of claim 5, wherein the acid zeolite is selected from the group consisting of: Y zeolites, Beta zeolites, ZSM-5 zeolites, Mordenite zeolites, Ferrierite zeolites, Al-MCM-41 zeolites, MCM-48 zeolites, MCM-22 zeolites, SAPO-34 zeolites, Chabazite zeolites, and combinations thereof.

8. The process of claim 1, further including hydrogenating the bio-oil prior to hydrodeoxygenating the bio-oil in the presence of a catalyst comprising a metal on a solid support at a hydrogen pressure selected to remove at least a quantity of oxygen-containing heteroatoms from the bio-oil.

9. The process of claim 8, wherein the metal is selected from the group consisting of: Ruthenium (Ru), Rhenium (Re), Palladium (Pd), Platinum (Pt), Nickel (Ni), and combinations thereof and the solid support is a selected from the group consisting of: titania (TiO₂), zirconia (ZrO₂), alumina (Al₂O₃), silica (SiO₂), and combinations thereof.

10. A process for upgrading a bio-oil, comprising:
hydrogenating the bio-oil with a catalyst comprising a metal on a solid support at a hydrogen pressure selected to remove at least a quantity of oxygen-containing heteroatoms from the bio-oil; and
hydrodeoxygenating the bio-oil in the presence of a bi-functional catalyst comprising both a metal on a solid support and a solid acid or a metal on a solid acid support at a hydrogen pressure and temperature selected to form a product bio-oil comprising fuel range hydrocarbons.

11. The process of claim 10, wherein the bio-oil is a catalytic fast pyrolysis bio-oil or a non-catalytic fast pyrolysis bio-oil obtained from a wood-derived biomass.

12. The process of claim 10, wherein the hydrogenation and the hydrodeoxygenation of the bio-oil are performed in the same reactor.

13. The process of claim 10, wherein the hydrogenation and the hydrodeoxygenation of the bio-oil are performed in separate reactors or separate reactor stages.

14. The process of claim 13, wherein the hydrogenation of the bio-oil is performed in a reactor or reactor stage directly coupled to a reactor or reactor stage that performs the hydrodeoxygenation.

15. The process of claim 10, wherein the hydrogenation is performed in a first stage reactor or a first stage of a two-stage reactor at a temperature below 200° C. in hydrogen (H₂) gas at a pressure between about 3.0 MPa and about 12.0 MPa.

16. The process of claim 10, wherein the hydrodeoxygenation is performed in a single stage reactor or a second stage of a two-stage reactor over the bi-functional catalyst at a temperature of from about 200° C. to about 400° C. in hydrogen (H₂) gas at a pressure between about 3.0 MPa and about 12.0 MPa.

17. The process of claim 10, wherein the solid supported metal catalyst is a component of a single stage hydrogenation reactor or a first stage of a two stage reactor, and the bi-functional catalyst is a component of a single stage reactor or a second stage of the two stage reactor.

18. The process of claim 10, wherein the metal is selected from the group consisting of: Ruthenium (Ru), Rhenium (Re), Palladium (Pd), Platinum (Pt), Nickel (Ni), and combinations thereof, and the solid support is selected

19. The process of claim 10, wherein the solid support is selected from the group consisting of: titania (TiO₂), zirconia (ZrO₂), alumina (Al₂O₃), silica (SiO₂), and combinations thereof.

20. A bi-functional catalyst for upgrading bio-oils to produce fuel-range hydrocarbons therein, the bi-functional catalyst comprising:
a metal on a solid metal oxide support combined with a solid acid comprising an acidic metal oxide and/or an acid zeolite at selected concentrations; or a metal on an acidic metal oxide support and/or an acid zeolite support.

21. The catalyst of claim 20, wherein the metal is selected from the group consisting of: Ruthenium (Ru), Rhenium (Re), Palladium (Pd), Platinum (Pt), Nickel (Ni), and combinations thereof, and the solid support is selected

22. The catalyst of claim 20, wherein the acidic metal oxide or the acidic metal oxide support is selected from the group consisting of: titania (TiO₂), zirconia (ZrO₂), amorphous silica alumina (Al₂O₃—SiO₂), niobic acid, tungstic acid, molybdic acid, and combinations thereof.

23. The catalyst of claim 20, wherein the acid zeolite or the acidic zeolite support is selected from the group consisting of: Y zeolites, Beta zeolites, ZSM-5 zeolites, Mordenite zeolites, Ferrierite zeolites, Al-MCM-41 zeolites, MCM-48 zeolites, MCM-22 zeolites, SAPO-34 zeolites, Chabazite zeolites, and combinations thereof.

24. The catalyst of claim 20, wherein the metal has a concentration of from about 0.5 wt % to about 10 wt %, the solid metal oxide support has a concentration between about 20 wt % and about 90 wt %, and the solid acid includes a concentration between about 10 wt % and about 80 wt %.

25. The catalyst of claim 20, wherein the metal has a concentration of from about 0.5 wt % to about 10 wt %, and the solid acid support includes a concentration between about 90 wt % and about 99.5 wt %.

26. A system for upgrading bio-oils, the system comprising:
a first reactor or reactor stage pressurized with hydrogen gas and containing a catalyst comprising a metal on a solid support that hydrogenates a bio-oil introduced therein at a temperature and pressure selected to remove a quantity of oxygen-containing heteroatoms from the bio-oil that stabilizes the bio-oil; and
a second reactor or reactor stage pressurized with hydrogen gas and containing a bi-functional catalyst comprising both a metal on a solid support and a solid acid that hydrodeoxygenates the bio-oil hydrogenated in the first reactor or stage at a temperature and pressure selected to form a product bio-oil comprising fuel range hydrocarbons.

27. The system of claim 26, wherein the first reactor or reactor stage employs a temperature below 200° C. and a hydrogen (H₂) gas pressure of between about 3.0 MPa and about 12.0 MPa.

28. The system of claim 26, wherein the second reactor or reactor stage employs a temperature between about 200° C. and about 400° C. at a hydrogen (H₂) gas pressure between about 3.0 MPa and about 12.0 MPa.
